(19) United States
(12) Patent Application Publication
(10) Pub. No.: US 2026/0229147 A1
(43) Pub. Date: Aug. 6, 2026

(54) ARTIFICIAL BLOOD VESSEL SUTURING PRACTICE KIT FOR TRAINING AND EDUCATION, SIMILAR TO HUMAN BLOOD VESSELS AND CAPABLE OF MOVING AND CONTROLLING FLUID

(71) Applicant: KNU-Industry Cooperation Foundation, Gangwon-do (KR)

(72) Inventor: Kwang Ho LEE, Seoul (KR)

(21) Appl. No.: 19/052,667

(22) Filed: Feb. 13, 2025

(30) Foreign Application Priority Data
Feb. 4, 2025 (KR) 10-2025-0013470

(51) Int. Cl. G09B 23/30; G09B 23/32

(52) U.S. Cl. CPC G09B 23/303; G09B 23/32

(57) ABSTRACT

Provided is an artificial blood vessel suturing practice kit for training and education, similar to human blood vessels and capable of moving and controlling a fluid. The artificial blood vessel suturing practice kit may allow users to improve their skills by practicing under conditions similar to actual surgery and may enhance proficiency through repeated practice by simply replacing the artificial blood vessel. Furthermore, it is advantageous that sufficient training before performing vascular procedures and surgeries on actual patients may help prevent medical accidents.

### CROSS-REFERENCE TO RELATED APPLICATION

This application claims priority to Korean Patent Application No. 10-2025-0013470 filed on Feb. 4, 2025 and all the benefits accruing therefrom under 35 U.S.C. § 119, the contents of which are incorporated by reference in their entirety.

### FIELD

The present disclosure relates to an artificial blood vessel suturing practice kit, and more particularly to an artificial blood vessel suturing practice kit for training and education, similar to human blood vessels and is capable of moving and controlling a fluid, allowing users to practice suturing artificial blood vessels used as substitutes for actual blood vessels under realistic conditions, thereby allowing them to become proficient in actual vascular surgery.

### BACKGROUND

Vascular surgery is an essential procedure in all surgical fields and serves as a critical factor in determining surgical outcomes, necessitating a sufficient training process.

Additionally, since cardiovascular diseases are among the leading causes of death worldwide, training specialized medical professionals proficient in vascular surgery is an essential requirement.

However, since blood vessels are highly important, making surgical practice essential, they are also extremely sensitive structures, which limits opportunities for trainees to directly perform surgery on a patient's blood vessels to develop their skills, thereby creating a need for an appropriate surgical training model.

Currently available vascular surgery models use pipe-shaped artificial blood vessels designed to mimic the texture of actual blood vessels, allowing trainees to practice suturing using needles, forceps, and sutures. However, these models are of poor quality and fail to provide a realistic experience, making them insufficient for effective vascular surgery training.

### PRIOR ART DOCUMENTS

### Patent Document

(Patent Document) Korean Patent Registration No. 10-1871097

### Non-Patent Documents

m.11st.co.kr/products/ma/3592692766?

inpu=&trTypeCd=22&trCtgrNo=895019

### SUMMARY

The present disclosure provides an artificial blood vessel suturing practice kit for training and education, similar to human blood vessels and is capable of moving and controlling a fluid, which allows for suturing practice under conditions similar to actual surgical environments using an artificial blood vessel manufactured to simulate the diameter, thickness, and elasticity of real blood vessels.

In accordance with another exemplary embodiment, an artificial blood vessel suturing practice kit for training and education, which is similar to human blood vessels and is capable of moving and controlling a fluid, the artificial blood vessel suturing practice kit including: a storage tank configured to store artificial blood or water; a fluid conduit through which the artificial blood or water supplied from the storage tank flows; a first fitting valve provided on the fluid conduit to control the flow of the artificial blood or water; an artificial blood vessel having one end connected to the first fitting valve to receive the artificial blood or water, wherein, when a torn portion occurs, the artificial blood vessel is sutured using a needle and a suture thread; and a second fitting valve connected to the other end of the artificial blood vessel 40 to control the flow of the artificial blood or water.

The second fitting valve may be installed to be movable forward and backward in a longitudinal direction of the artificial blood vessel.

A slider may be provided below the second fitting valve to move forward and backward along the longitudinal direction of the artificial blood vessel, and a fixed block may be is provided below the slider to support the slider, wherein the slider has protrusions provided on a side surface thereof, and the fixed block may have a plurality of insertion holes into which the protrusions are inserted and which are defined in a side surface thereof along the longitudinal direction of the artificial blood vessel.

Here, a slider may be provided below the second fitting valve to move forward and backward along the longitudinal direction of the artificial blood vessel, and a fixed block is provided below the slider to support the slider, wherein the slider has recessed grooves defined in a side surface thereof so that a spring and an insertion ball may be disposed inside each of the recessed grooves to receive elastic force in a direction of pushing the insertion ball outward, and the fixed block has an insertion hole into which a portion of the insertion ball protruding outward from the recessed groove may be inserted and which is defined in a side surface thereof along the longitudinal direction of the artificial blood vessel.

The first fitting valve and the fixed block may be installed on a top surface of a table having a predetermined height.

The artificial blood vessel suturing practice kit may further include a water tank configured to accommodate the table and receive the artificial blood or water leaking from the fluid conduit and the artificial blood vessel.

A mounting stand configured to mount a smartphone for image photographing is installed on the table or the water tank.

A pressurizer may be connected to the storage tank to discharge the artificial blood or water from the storage tank and supply the artificial blood or water to the fluid conduit using a pressure provided by the pressurizer.

The pressurizer may be a dropping pipette configured to apply the pressure inside the storage tank through a connection tube.

A pressure gauge may be installed on the fluid conduit to measure pressure of the artificial blood or water flowing through the fluid conduit.

The artificial blood vessel suturing practice kit may further include a holder configured to hold the storage tank and the pressure gauge.

The holder may include: a storage tank holding part configured to accommodate the storage tank; a pressure gauge holding part provided on a front surface of the storage tank holding part to accommodate the pressure gauge; and a support leg extending horizontally from a lower end of the storage tank holding part.

A rigid fastening tool may be connected between the first fitting valve and the artificial blood vessel and between the second fitting valve and the artificial blood vessel.

The rigid fastening tool may include: a fitting connection part connected to the first fitting valve and the second fitting valve; and a vessel connection part integrated with the fitting connection part and connected to the artificial blood vessel, wherein the vessel connection part has a diameter that gradually decreases toward the artificial blood vessel and is provided with a plurality of annular wedges protruding on an outer circumferential surface thereof.

### BRIEF DESCRIPTION OF THE DRAWINGS

Exemplary embodiments can be understood in more detail from the following description taken in conjunction with the accompanying drawings, in which:

FIGS. 1, 2, 3 and 4 are views illustrating an artificial blood vessel suturing practice kit for training and education, similar to human blood vessels and capable of fluid movement and control, according to the present invention.

FIG. 5 is a view illustrating an embodiment of a slider and a fixing block applied to the artificial blood vessel suturing practice kit for training and education, similar to human blood vessels and capable of fluid movement and control, according to the present invention.

FIG. 6 is a view illustrating another embodiment of a slider and a fixing block applied to the artificial blood vessel suturing practice kit for training and education, similar to human blood vessels and capable of fluid movement and control, according to the present invention.

FIG. 7 is a view illustrating extension of the artificial blood vessel in an artificial blood vessel suturing practice kit for training and education, similar to human blood vessels and capable of fluid movement and control, according to the present invention.

FIG. 8 is a view illustrating a holder applied to an artificial blood vessel suturing practice kit for training and education, similar to human blood vessels and capable of fluid movement and control, according to the present invention.

### DETAILED DESCRIPTION

Hereinafter, embodiments of an artificial blood vessel suturing practice kit for training and education, similar to human blood vessels and capable of fluid movement and control, according to the present invention will be described in detail with reference to the accompanying drawings.

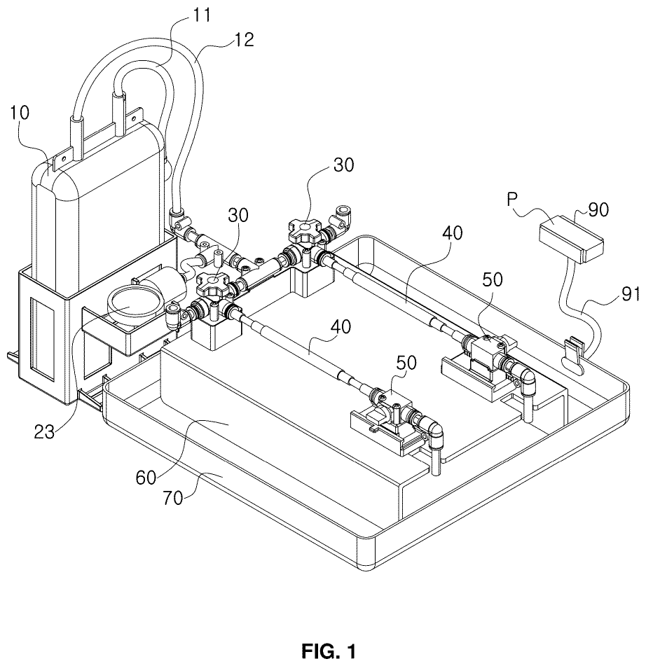

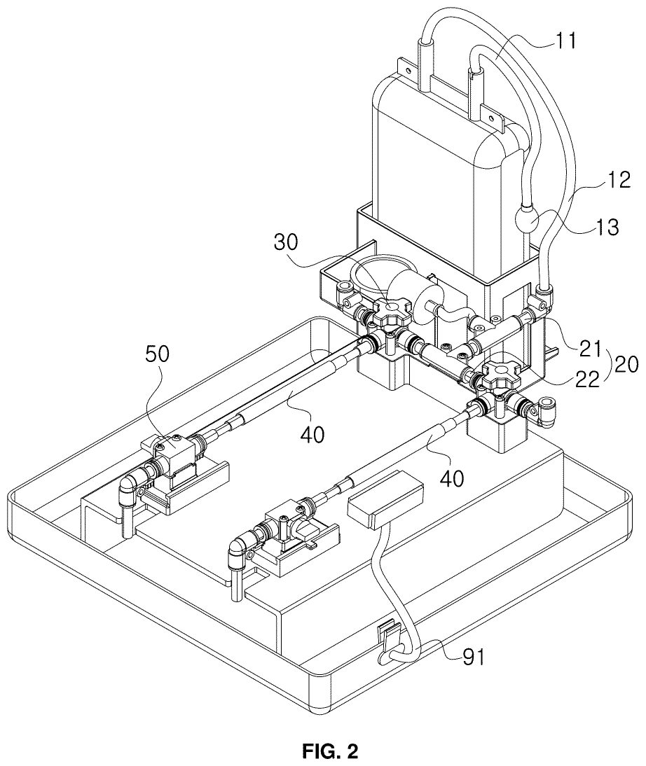

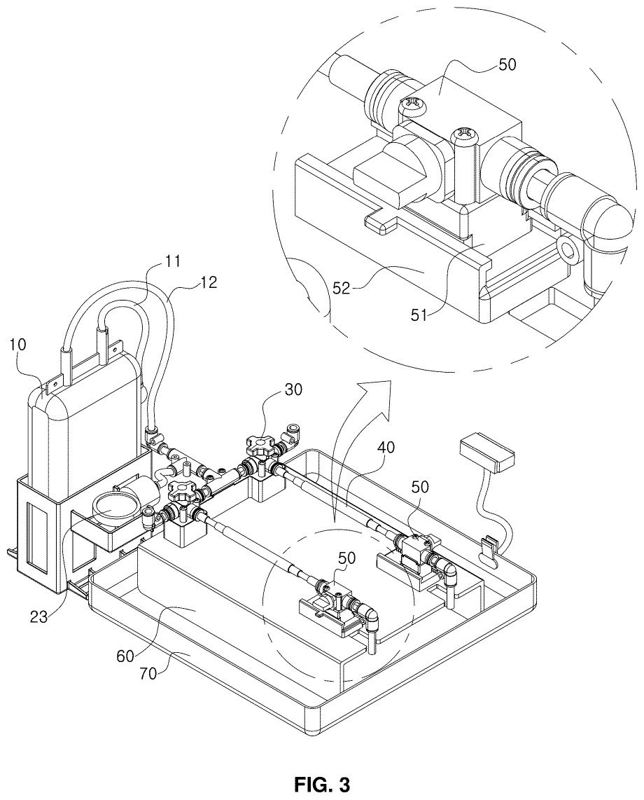

FIGS. 1 to 4 are views illustrating an artificial blood vessel suturing practice kit for training and education, similar to human blood vessels and capable of fluid movement and control, according to the present invention.

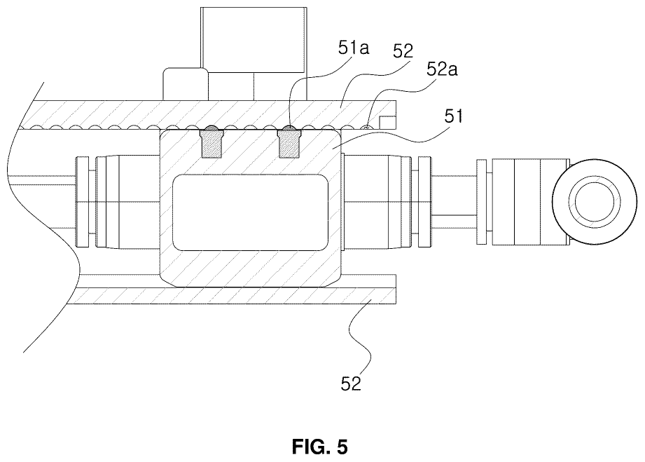

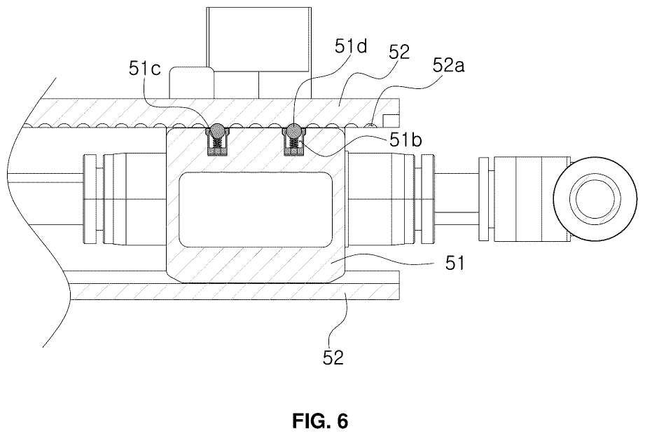

FIG. 5 is a view illustrating an embodiment of a slider and a fixing block applied to the artificial blood vessel suturing practice kit for training and education, similar to human blood vessels and capable of fluid movement and control, according to the present invention, and FIG. 6 is a view illustrating another embodiment of a slider and a fixing block applied to the artificial blood vessel suturing practice kit for training and education, similar to human blood vessels and capable of fluid movement and control, according to the present invention.

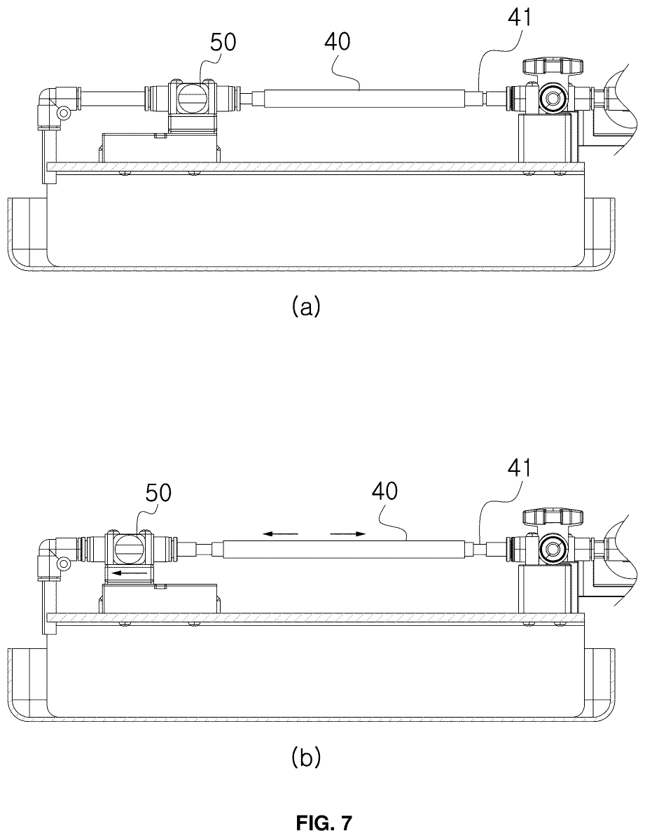

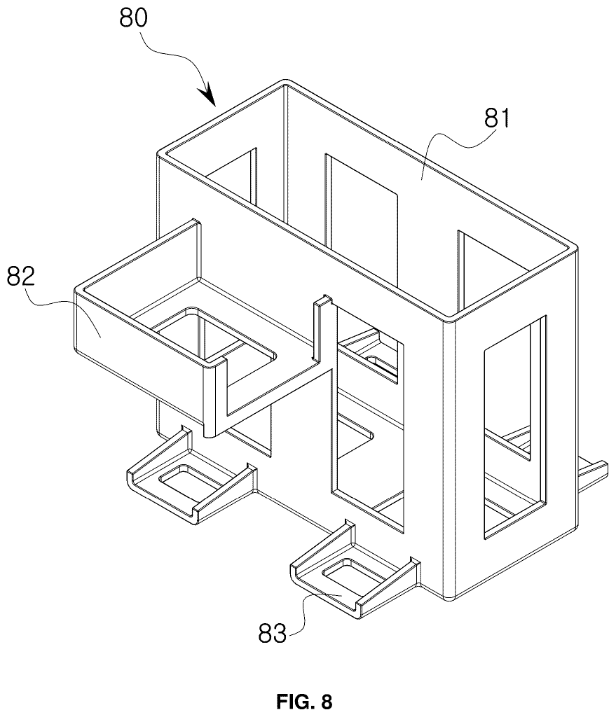

FIG. 7 is a view illustrating extension of the artificial blood vessel in an artificial blood vessel suturing practice kit for training and education, similar to human blood vessels and capable of fluid movement and control, according to the present invention, and FIG. 8 is a view illustrating a holder applied to an artificial blood vessel suturing practice kit for training and education, similar to human blood vessels and capable of fluid movement and control, according to the present invention.

The artificial blood vessel suturing practice kit for training and education, similar to human blood vessels and capable of fluid movement and control, according to the present invention, is designed to allow practitioners to practice suturing artificial blood vessels by simulating scenarios such as blood leakage due to a torn artificial blood vessel and various other conditions. The artificial blood vessel suturing practice kit may include a storage tank 10 configured to store artificial blood or water, a fluid conduit 20 supplied with artificial blood or water from the storage tank 10, a first fitting valve 30 provided on the fluid conduit 20, an artificial blood vessel 40 having one end connected to the first fitting valve 30, a second fitting valve 50 connected to the other end of the artificial blood vessel 40, a table 60 on which the first fitting valve 30 is disposed, a water tank 70 configured to accommodate the table 60 therein, and a holder 80 configured to support the storage tank 10.

The storage tank 10 may store artificial blood or water therein and be connected to a pressurizer 13 through a connection tube 11 and to a fluid conduit 20 through an injection tube 12.

The pressurizer 13 may provide pressure inside the storage tank 10, thereby discharging the artificial blood or water from the storage tank 10. Specifically, when the pressure provided by the pressurizer 13 increases the internal pressure of the storage tank 10, the artificial blood or water stored in the storage tank 10 may be discharged through the injection tube 12 and flow into the fluid conduit 20.

Here, the pressurizer 13 may be provided as a dropping pipette that applies pressure inside the storage tank 10 through the connection tube 11 or as a small pump. When the pressurizer is a dropping pipette, the practitioner may repeatedly press the dropping pipette manually to discharge the artificial blood or water, whereas when the pressurizer is a small pump, the small pump may automatically apply pressure to the storage tank 10 to discharge the artificial blood or water.

The fluid conduit 20 may be provided by combining a plurality of tubes and a plurality of fittings, allowing artificial blood or water supplied from the storage tank 10 to flow therethrough.

The fluid conduit 20 may include a main conduit 21 connected to the injection tube 12 and a branch conduit 22 that diverges from the end of the main conduit 21. In the training model of the present invention, if a single artificial blood vessel 40 is used, one main conduit 21 may be sufficient without a branch conduit 22. However, if two or more artificial blood vessels 40 are used, the number of branch conduits 22 should correspond to the number of artificial blood vessels 40.

Assuming that practitioners gather around the training model of the present invention to practice suturing artificial blood vessels, it is preferable to adopt two artificial blood vessels 40 so that one person may practice suturing on each artificial blood vessel 40 from opposite sides. Therefore, the following description will be based on the assumption that two branch conduits 22 are provided, as illustrated in the drawings.

Meanwhile, a pressure gauge 23 may be installed on the fluid conduit 20 to measure the pressure of the artificial blood or water flowing through the fluid conduit 20. More specifically, the pressure gauge 23 may be installed on the main conduit 21 to measure the pressure of the fluid flowing through the main conduit 21. Accordingly, as the pressurizer 13 applies and adjusts pressure, it may be possible to check for any leakage in the artificial blood vessel 40.

The first fitting valve 30 may control the flow of artificial blood or water within the fluid conduit 20. Here, one first fitting valve 30 may be installed on each branch conduit 22.

Specifically, the first fitting valve 30 may block the branch conduit 22 to stop the flow of artificial blood or water within the branch conduit 22, or may allow flow only in a direction of the artificial blood vessel 40 while blocking the other directions to ensure that the artificial blood or water flows exclusively toward the artificial blood vessel 40.

The artificial blood vessel 40 may be designed to simulate an actual blood vessel and receive artificial blood or water flowing through the fluid conduit 20 via the first fitting valve 30. This artificial blood vessel 40 may be manufactured by electrospinning a polyurethane polymer and layering nanofibers on the surface to create numerous micropores, thereby providing flexibility and elasticity.

During suturing practice, a specific portion of the artificial blood vessel 40 may be incised or torn, creating an opening portion that practitioners may suture using a needle and suture thread. As the incision or torn area is sutured with suture thread, the artificial blood or water stored in the storage tank 10 may flow through the artificial blood vessel 40, and any improperly sutured sections may allow leakage of artificial blood or water from the artificial blood vessel 40. This leakage of artificial blood or water may allow practitioners to visually identify areas where the suturing is incomplete, allowing them to gain experience and improve their suturing skills.

The second fitting valve 50 may be connected to the other end of the artificial blood vessel 40 to control the flow of artificial blood or water inside the artificial blood vessel 40. That is, depending on the operation of the second fitting valve 50, the artificial blood or water may be discharged to the outside, or may remain contained within the artificial blood vessel 40.

The second fitting valve 50 may be installed to move forward and backward along a longitudinal direction of the artificial blood vessel 40, allowing the artificial blood vessel 40 to expand and contract.

More specifically (refer to FIGS. 5 and 7), a slider 51 may be disposed below the second fitting valve 50, and a fixing block 52 may be disposed below the slider 51 to support the slider 51 while allowing the slider 51 to move forward and backward.

The slider 51 may be integrated with the second fitting valve 50, so when the slider 51 moves forward and backward, the second fitting valve 50 moves accordingly. The slider 51 has a protrusion 51a provided on a side surface thereof.

The fixing block 52 may have a plurality of insertion holes 52a in a side surface thereof, into which the protrusion 51a is inserted. These insertion holes 52a may be defined at regular intervals along the longitudinal direction of the artificial blood vessel 40.

Accordingly, when the slider 51 moves a certain distance on the fixing block 52 and then stops, the protrusion 51a may be inserted into the insertion hole 52a at the corresponding position, thereby maintaining the stop position.

Meanwhile, the sliding structure of the slider 51 relative to the fixing block 52 may be provided as follows (refer to FIG. 6).

The slider 51 may be integrated with a lower portion of the second fitting valve 50, and a fixing block 52 may be provided below the slider 51 to support the slider 51 while ensuring that the slider 51 moves forward and backward stably along the longitudinal direction of the artificial blood vessel 40.

A recessed groove 51b may be defined in a side surface of the slider 51, and a spring 51c and an insertion ball 51d may be inserted into the recessed groove 51b. Since the insertion ball 51d may be pushed outward by the elastic force provided by the spring 51c, a portion of the spherical insertion ball 51d may protrude outside the recessed groove 51b.

The fixing block 52 may have insertion holes 52a in a side surface thereof, and a portion of the protruding portion of the insertion ball 51d may be inserted into the insertion holes 52a. Here, the insertion holes 52a may be defined long the longitudinal direction of the artificial blood vessel 40.

Thus, when the slider 51 is pushed, the insertion ball 51d may be pressed against the side surface of the fixing block 52 and move inward into the recessed groove 51b. When it reaches the insertion hole 52a, a portion of the insertion ball 51d may protrude outward due to the elastic force of the spring 51c, repeating the process of being inserted into the insertion hole 52a.

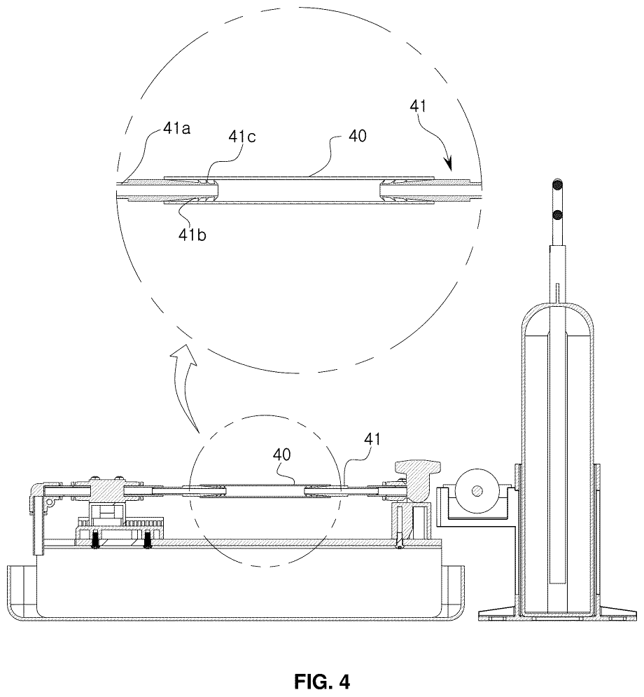

Here, the connection structure of both ends of the artificial blood vessel 40 with the first fitting valve 30 and the second fitting valve 50 will be briefly described (see FIG. 4).

Since the artificial blood vessel 40 is made of a thin, highly flexible, and soft elastic material, both ends of the artificial blood vessel 40 cannot be directly connected to the first fitting valve 30 and the second fitting valve 50. Thus, a fastening tool 41, made of a rigid material having a certain strength and hardness, may be connected between the first fitting valve 30 and the artificial blood vessel 40, and between the second fitting valve 50 and the artificial blood vessel 40.

The fastening tool 41 may include a fitting connection part 41a connected to the first fitting valve 30 and the second fitting valve 50, and a vessel connection part 41b, which is integrated with the fitting connection part 41a and connected to the artificial blood vessel 40.

The vessel connection part 41b may be provided with a uniform diameter throughout or may gradually decrease in diameter as it approaches the artificial blood vessel 40. A plurality of annular wedges 41c of equal height may protrude on an outer circumferential surface of the vessel connection part 41b.

From the perspective of connecting various artificial blood vessels 40, it is preferable that the vessel connection part 41b gradually decreases in diameter toward the artificial blood vessel 40.

That is, artificial blood vessels 40 are manufactured with different diameters. when the vessel connection part 41b has a conical shape that decreases in diameter toward the artificial blood vessel 40, various artificial blood vessels 40 with different diameters may be easily connected to the vessel connection part 41b.

Additionally, since the outer circumferential surface of the vessel connection part 41b is provided with annular wedges 41c, when the vessel connection part 41b is inserted into the artificial blood vessel 40, the artificial blood vessel 40 may be restrained by the annular wedges 41c and not be easily detach from the vessel connection part 41b.

The table 60 may have a horizontal plate shape with a certain height. The fixing block 52 supporting the first fitting valve 30 and the second fitting valve 50 may be disposed on a top surface of the table 60. The artificial blood vessel 40 may be disposed at a certain distance above the table 60.

The water tank 70 may have an open-top box shape and the table 60 may be accommodated to the water tank 70. The water tank 70 may receive artificial blood or water leaking from the conduit 20 and the artificial blood vessel 40. Thus, all the water used during artificial blood vessel suturing practice may be collected in the water tank 70, post-practice cleanup may be facilitated.

Meanwhile, a mounting stand 90 configured to mount a smartphone P for image photographing is installed on either the table 60 or the water tank 70. That is, the suturing practice performed on the artificial blood vessel 40 may be photographed using the smartphone P, which may be useful for reviewing the practice later.

The mounting stand 90 may have a support bar 91 that is located at a position enough to allow the smartphone P is disposed above the table 60. Additionally, the support bar 91 may be made highly flexible to eliminate blind spots, allowing for easy adjustment of the smartphone P's position.

The holder 80 may be configured to hold the storage container 10 and the pressure gauge 23. The holder 80 may include a storage tank holding part 81 that accommodates the storage container 10, a pressure gauge holding part 82 that accommodates the pressure gauge 23, and a support leg 83 provided at a lower end of the storage tank holding part 81.

The storage tank holding part 81 may be disposed next to the water tank 70 during suturing practice to securely hold the storage tank 10, which supplies artificial blood or water necessary for the practice.

The pressure gauge holding part 82 may protrude from a front surface of the storage tank holding part 81 and accommodates the pressure gauge 23, which is installed on the main conduit 21.

The support legs 83 may extend horizontally from the lower end of the storage tank holding part 81, preventing the holder 80 from shaking during suturing practice.

The artificial blood vessel suturing practice kit for training and education, similar to human blood vessels and capable of fluid movement and control, configured as described above, may allow users to improve their skills by practicing under conditions similar to actual surgery and may enhance proficiency through repeated practice by simply replacing the artificial blood vessel.

Furthermore, it is advantageous that sufficient training before performing vascular procedures and surgeries on actual patients may help prevent medical accidents.

Although the artificial blood vessel suturing practice kit, and more particularly to an artificial blood vessel suturing practice kit for training and education, similar to human blood vessels and capable of fluid movement and control, has been described with reference to the specific embodiments, it is not limited thereto. Therefore, it will be readily understood by those skilled in the art that various modifications and changes can be made thereto without departing from the spirit and scope of the present invention defined by the appended claims.

### DESCRIPTION OF REFERENCE NUMERALS

10: Storage tank
11: Connection tube
12: Injection tube
13: Pressurizer
20: Fluid conduit
21: Main conduit
22: Branch conduit
23: Pressure gauge
30: First fitting valve
40: Artificial blood vessel
41: Fastening tool
41a: Fitting connection part
41b: Vessel connection part
41c: Annular wedge
50: Second fitting valve
51: Slider
51a: Protrusion
51b: Recessed groove
51c: Spring
51d: Insertion ball
52: Fixing block
52a: Insertion hole
60: Table
70: Water tank
80: Holder
81: Storage tank holding part
82: Pressure gauge holding part
83: Support leg
90: Mounting stand
91: Support bar
P: Smartphone

What is claimed is:

1. An artificial blood vessel suturing practice kit for training and education, which is similar to human blood vessels and is capable of moving and controlling a fluid, the artificial blood vessel suturing practice kit comprising:
a storage tank configured to store artificial blood or water;
a fluid conduit through which the artificial blood or water supplied from the storage tank flows;
a first fitting valve provided on the fluid conduit to control the flow of the artificial blood or water;
an artificial blood vessel having one end connected to the first fitting valve to receive the artificial blood or water, wherein, when a torn portion occurs, the artificial blood vessel is sutured using a needle and a suture thread; and
a second fitting valve connected to the other end of the artificial blood vessel 40 to control the flow of the artificial blood or water.

2. The artificial blood vessel suturing practice kit of claim 1, wherein the second fitting valve is installed to be movable forward and backward in a longitudinal direction of the artificial blood vessel.

3. The artificial blood vessel suturing practice kit of claim 1, wherein a slider is provided below the second fitting valve to move forward and backward along the longitudinal direction of the artificial blood vessel, and
a fixed block is provided below the slider to support the slider,
wherein the slider has protrusions provided on a side surface thereof, and
the fixed block has a plurality of insertion holes into which the protrusions are inserted and which are defined in a side surface thereof along the longitudinal direction of the artificial blood vessel.

4. The artificial blood vessel suturing practice kit of claim 2, wherein a slider is provided below the second fitting valve to move forward and backward along the longitudinal direction of the artificial blood vessel, and
a fixed block is provided below the slider to support the slider,
wherein the slider has recessed grooves defined in a side surface thereof so that a spring and an insertion ball are disposed inside each of the recessed grooves to receive elastic force in a direction of pushing the insertion ball outward, and
the fixed block has an insertion hole into which a portion of the insertion ball protruding outward from the recessed groove is inserted and which is defined in a side surface thereof along the longitudinal direction of the artificial blood vessel.

5. The artificial blood vessel suturing practice kit of claim 3, wherein the first fitting valve and the fixed block are installed on a top surface of a table having a predetermined height.

6. The artificial blood vessel suturing practice kit of claim 5, further comprising a water tank configured to accommodate the table and receive the artificial blood or water leaking from the fluid conduit and the artificial blood vessel.

7. The artificial blood vessel suturing practice kit of claim 5, wherein a mounting stand configured to mount a smartphone for image photographing is installed on the table or the water tank.

8. The artificial blood vessel suturing practice kit of claim 1, wherein a pressurizer is connected to the storage tank to discharge the artificial blood or water from the storage tank and supply the artificial blood or water to the fluid conduit using a pressure provided by the pressurizer.

9. The artificial blood vessel suturing practice kit of claim 8, wherein the pressurizer is a dropping pipette configured to apply the pressure inside the storage tank through a connection tube.

10. The artificial blood vessel suturing practice kit of claim 1, wherein a pressure gauge is installed on the fluid conduit to measure a pressure of the artificial blood or water flowing through the fluid conduit.

11. The artificial blood vessel suturing practice kit of claim 10, further comprising a holder configured to hold the storage tank and the pressure gauge.

12. The artificial blood vessel suturing practice kit of claim 11, wherein the holder comprises:
a storage tank holding part configured to accommodate the storage tank;
a pressure gauge holding part provided on a front surface of the storage tank holding part to accommodate the pressure gauge; and
a support leg extending horizontally from a lower end of the storage tank holding part.

13. The artificial blood vessel suturing practice kit of claim 1, wherein a rigid fastening tool is connected between the first fitting valve and the artificial blood vessel and between the second fitting valve and the artificial blood vessel.

14. The artificial blood vessel suturing practice kit of claim 13, wherein the rigid fastening tool comprises:
a fitting connection part connected to the first fitting valve and the second fitting valve; and
a vessel connection part integrated with the fitting connection part and connected to the artificial blood vessel,
wherein the vessel connection part has a diameter that gradually decreases toward the artificial blood vessel and is provided with a plurality of annular wedges protruding on an outer circumferential surface thereof.

15. The artificial blood vessel suturing practice kit of claim 4, wherein the first fitting valve and the fixed block are installed on a top surface of a table having a predetermined height.
